(19) United States
(12) Patent Application Publication
(10) Pub. No.: US 2023/0389716 A1
(43) Pub. Date: Dec. 7, 2023

(54) CIRCULAR FOAM FOR CUSHIONS AND MATRASSES, CUSHION AND MATRASS PROVIDED THEREWITH, AND METHOD FOR MANUFACTURING SUCH FOAM

(71) Applicant: FOAMPLANT B.V., GRONINGEN (NL)

(72) Inventors: Martin TIETEMA, GRONINGEN (NL); Martijn BELJAARS, GRONINGEN (NL); Vincent VAN ASSEN, GRONINGEN (NL); Wilfred ROO, GRONINGEN (NL)

(73) Assignee: FOAMPLANT B.V., GRONINGEN (NL)

(21) Appl. No.: 18/034,281

(22) PCT Filed: Oct. 29, 2021
(86) PCT No.: PCT/NL2021/050664

§ 371 Date: Apr. 27, 2023

(30) Foreign Application Priority Data
Oct. 30, 2020 (NL) 2026802

(51) Int. Cl. A47C 27/14; C08J 9/00; C08J 9/12; A47C 27/06

(52) U.S. Cl. CPC A47C 27/14; C08J 9/0061; C08J 9/12; C08J 2367/02; C08J 2205/05; C08J 2205/044; C08J 2201/03; A47C 27/064

(57) ABSTRACT

A circular foam for cushions and mattresses, cushions and mattresses provided therewith, and method for manufacturing such foam. The circular foam for cushions and mattresses includes a circular polymer and a nucleating agent, where the circular polymer is a polyester and/or an aromatic polymer, the circular foam includes an open cell structure, and a fatigue of at most 15% as determined according to ISO 1856:2018.

The present invention relates to a circular foam for cushions and/or matrasses, a cushion and/or matrass provided therewith, method for manufacturing such foam, circular foam for cushions and/or matrasses obtainable by said method, and use of said circular foam in matrasses and/or cushions.

In practice, foams are used for cushions and matrasses. Such foams for cushions and matrasses are known from conventional matrasses, pillows from couches, seats, and the like. The conventional foams may be applied for cushioning, for example. Conventional foams are manufactured from a virgin synthetic material, such as polyurethane, polyether, and/or latex. Often, the foam provides comfort and/or isolation. Furthermore, said foams degrades over time, and therewith loses its performance.

One of the problems with such synthetic foams manufactured from virgin synthetic material relates to the fact that these foams are made of virgin synthetic material that render it difficult to reduce the environmental impact of said foam. In addition, in practice one is confronted with the non sustainability of said foam and the fact that said foam is often non biodegradable.

The present invention has for its object to provide a foam that obviates or at least reduces one or more of the aforementioned problems.

This is achieved with the circular foam according to the invention for cushions and matrasses, comprising a circular polymer and a nucleating agent, wherein the circular polymer is a polyester and/or an aromatic polymer, wherein the circular foam comprise an open cell structure, and a fatigue of at most 15% as determined according to ISO 1856:2018.

It is noted that in this application substrate and foam substrate and circular foam substrate may be used interchangeably and refer to the same subject. Furthermore, it is noted that in this application that cushion refers to objects such as pillow, cushioning, cushion, pad, bolster, and the like.

Furthermore, it is noted that the fatigue of at most 15% is determined according to method B of ISO 1856:2018. This is also referred to as ISO 1856-B:2018.

It is also noted that in this application virgin material, virgin polymer, and virgin foam relate to a first use of the material, polymer, and foam. In other words, virgin relates to material, polymers, and foam which is derived from originating sources such as oil, plants, and the like.

The circular foam according to the present invention comprises a circular polymer which is a polyester and/or an aromatic polymer. In the context of this invention circular polymer relates to virgin-like polymer which may be used as a replacement of virgin (fossil based) polymers. As such, the circular polymers may have similar properties compared to virgin polymers. In other words, to obtain a circular polymer, polymeric waste, such as foam waste, is recycled wherein the high quality of the polymer is maintained and a loss of properties if prevented. Therefore, the circular polymer may be part of (old) circular foam, wherein the foam may be used as source for circular polymers.

Circular or circularity refers to a system of closed loops in which raw materials, components, and products lose as little of their value as possible and are ideally re-used for 100%. In other words, the system aims at eliminating waste and continuous use of resources. Therefore, a circular foam refers to a foam derived from raw materials that are waste from a similar or different application. The foam preferably has the same properties and/or had same use. Thus, after being processed to foam, the circular polymer retains the mechanical properties so that it can be processed as, and is mechanically similar to virgin polymer material.

An advantage of the circular polymer is that said polymers significantly reduce the environmental footprint of cushions and matrasses. For example, cushions and matrasses are often disposed and combusted.

The circular foam according to the present invention further comprises an open cell structure, and a fatigue of at most 15% as determined according to ISO 1856:2018, preferably method B of ISO 1856:2018. The open cell structure of the circular foam enables light weight materials, as a result the weight of products the circular foam according to the invention is used for is limited. Furthermore, it was found that the open cell structure of the circular foam according to the invention provides support as a result this indulges the comfort for users, for example when the circular foam structure according to the invention is used in seats, cushions, or matrasses.

An advantage of the circular foam according to the invention comprising a fatigue of at most 15% is that the circular foam degrades slowly and keeps its flexibility. As a result, the circular foam according to the invention returns to substantially the same form after use. To determine the fatigue of the circular foam according to the invention, the ISO 1856:2018 norm, preferably method B of the ISO 1856:2018 norm may be used. This results in the cushion or matrass having both a stabilizing/fixation effect and in addition thereto a comforting effect due to the formability of the circular foam. This renders the circular foam according to the invention also cost effective and efficient. As a further effect, the disposal of the circular foam is much easier, thereby contributing to a reduction of the environmental footprint. For example, a disposed foam may be used to form new circular foam which may have substantially similar properties compared to a foam manufactured from virgin material.

An even further advantage of the circular foam according to the present invention is that the foam particle is dimensionally stable. In respect of the invention, this means that the circular foam has a flexible shape that is compressible and expandable. The circular foam will return to the original shape when bended, compressed and/or expanded. The effect of the dimensional stability is that the circular foam is easily transportable and easily to apply in furniture, matrasses, noise reduction, and cushioning. During transport the circular foam does not require severe protection.

Therefore, providing the soil particle as a circular foam with an open cell structure enables comfortability, flexibility, and stability. This significantly reduces pain (pain whilst sitting or laying down on said circular foam) or discomfort whilst using the circular foam. Therefore, this contributes to the overall efficiency of comfort. Such open cell structure preferably relates to a sponge-type structure with a number of interconnected openings or voids or pores or cells. Such open cell structure has an advantage that a homogeneous and well-defined distribution of air and/or pressure in the foam is provided. Furthermore, the circular foam according to the invention provides the open cell structure enabling deformability which in turn promotes comfort, stability, and flexibility for the user.

Yet another advantage of the circular foam according to the invention is that the circular foam is hygienic and/or sterile. This results in a circular foam having a reducing effect on propagation of diseases and/or fungi and/or bacteria and/or insects such as dust mites. Said influences may cause severe (health) problems for humans.

Yet another advantage of the circular foam according to the invention is that the foam provides efficient and effective isolation and retains heat, such as body heat. Therefore, the circular foam may be used to retain body heat to a comfortable level without overheating.

Furthermore, it was found that the circular foam may be used to cancel noise. This enables the circular foam to be used as isolating material and/or noise cancelling material. For example, a cushion for a seat made from the circular foam according to the invention may be used in a room to provide comfortable seating and reduces the noise.

Another advantage of the circular foam according to the invention is that the foam is inert for water, sweat, urine and/or other liquids. This results in a sustainable circular foam which may be used as cushion and/or matrass.

Therefore, the circular foam according to the invention may be a replacement for virgin foam, reduces the global plastic waste problem, stops the depletion of natural resources, and facilitates a circular economy. In addition thereto, the circular foam according to the invention may be used as a resource to form new circular foam.

Experiments showed that the circular foam may be intensively used without severe degradation of the circular foam. For example, a cushion manufactured from the circular foam according to the invention was exposed to more than 100,000 pressure movements of 80 kg without severe degradation of the circular foam.

An even further advantage of the circular foam according to the present invention is that the circular foam is safe in use for manual handling. This implies that the circular foam can be used in a safe manner No further safety precautions, such as protective gloves, safety glasses, dust masks and the like are required when handling the circular foam.

Yet another advantage of the circular foam according to the invention is that the circular foam has fire retardant properties. It was found that the circular foam according to the invention slowed down fire and extinguished itself when set on fire in a controlled environment comprising only a piece of circular foam according to the invention, in this experiment having a size of 1 meter×1 meter×15 cm.

Therefore, this enables the use of the circular foam in products for humans.

It is noted that in this application circular foam comprises circular polymer. Therefore, in a preferred embodiment circular foam according to the invention is manufactured from circular foam comprising circular polymer.

In other words, circular foam comprising a circular polymer and a nucleating agent, may be used to manufacture (new) circular foam according to the invention. An advantage is that the (old) circular foam may be used to manufacture (new) circular foam according to the invention. The old circular foam material may also refer to reclaimed material or reclaimed foam, wherein the reclaimed foam comprises circular polymer and nucleating agent. In addition, reclaimed material may comprise additives.

In a preferred embodiment according to the invention, the circular foam comprises and/or releases less than 20 μg m⁻³ volatile organic compounds after 3 days as determined according to DIN EN 16516, preferably less than 17 μg m⁻³ volatile organic compounds after 3 days as determined according to DIN EN 16516.

Providing a circular foam with a value of 30 μg m⁻³ volatile organic compounds after 3 days as determined according to DIN EN 16516 or lower enables the circular foam to be used in applications for consumers.

In one of the presently preferred embodiments, the circular foam according to the invention comprises reclaimed foam, wherein the reclaimed foam comprises the circular polymer and a nucleating agent. Preferably, the fatigue of the circular foam may be at most 10%. Preferably, the fatigue of the circular foam may be at most 8%, more preferably at most 6%.

It is noted that the reclaimed foam may comprise further compounds such as additives. For example additives from a preferred embodiment.

Providing a circular foam wherein the fatigue of the circular foam is at most 10% enables a flexible circular foam with reduced loss of flexibility during use. It was found that a cushion manufactured from the circular foam wherein the fatigue may be at most 10% according to the invention was exposed to more than 110,000 pressure movements of 80 kg without severe degradation of the circular foam.

Furthermore, it was found that a cushion manufactured from the circular foam wherein the fatigue may be at most 8% or 6% according to the invention was exposed to more than 120,000 or more than 130,000 pressure movements of 80 kg without severe degradation of the circular foam respectively.

An advantage of the circular foam comprising a fatigue of at most 10% is that the circular foam has a prolonged lifetime.

In one of the presently preferred embodiments, the circular foam may comprise at least 70 wt. % circular polymer, preferably may comprises at least 80 wt. % circular polymer, more preferably may comprises at least 90 wt. % circular polymer.

An advantage of the circular foam comprising at least 70 wt. % circular polymer, preferably comprising at least 80 wt. % circular polymer, more preferably comprising at least 90 wt. % circular polymer, is that the environmental footprint of the circular foam according to the invention is reduced. Preferably, the circular foam according to the invention is substantially entirely made of circular materials.

It is noted that weight percentage (wt. %) throughout this application refers to the percentage of the weight a compound is contributing to the total weight of the circular foam. Furthermore, it is noted that the weight percentage is determined according to the dry weight of the circular foam.

In one of the presently preferred embodiments, the circular foam may comprise at most 30 wt. % virgin polymer, preferably may comprise at most 20 wt. % virgin polymer, more preferably may comprise at most 10 wt. % virgin polymer, and wherein the virgin polymer may be a biodegradable polymer.

An advantage of the virgin polymer is that the polymer is free of contamination and that the circular foam material may be provided with desired properties. As a result, the circular foam may be achieved with properties desired by the end user.

In one of the presently preferred embodiments, the circular polymer may be a biodegradable polymer.

Biodegradable relates in the context of this invention to degradation resulting in a loss of properties from the action of microorganisms such as bacteria, fungi and algae. By manufacturing the circular foam according to the invention from a biodegradable polymer an environmentally friendly foam for cushions and matrasses is achieved. This significantly reduces the environmental footprint of cushions and matrasses, and foams in general. As a further effect of the use of the biodegradable polymer, the foam is preferably also compostable. In the context of this invention compostable relates to degradation by biological processes resulting in the yield of carbon dioxide (CO₂), water, inorganic compounds and biomass. Therefore, the circular polymer which may be biodegradable in the circular foam according to the invention is capable of being degraded such that the water infrastructure and/or water treatment plants are prevented from clogging. Furthermore, the circular polymer in the circular foam according to the invention is dimensional stable which prevents accumulation of the circular foam causing blockages.

Furthermore, reclaiming/recycling the (circular) foam in a circular manner reduces the impact on landfill. This enables to lower the cost of landfill areas and reduces the impact on the environment.

In a preferred embodiment the circular foam meet the criteria for obtaining an OK COMPOST certification as stipulated by TUV Austria, or a comparable certificate which allows the disposal of these materials in industrial composting facilities. Preferably, the circular foam meets the criteria stipulated for conformity to OK COMPOST HOME, as stipulated by TUV Austria, or a comparable certificate which allows the disposal of these materials in home composting conditions.

Further experiments showed that the circular foam in some of the presently preferred embodiments could be composted within six months, preferably six days, applying standard composting conditions.

In a preferred embodiment of the invention, the circular foam may further comprise additives, wherein the additives are selected from the group of (natural) antimicrobials, bacteria retardants, such as silver compounds, chitin, chitosan, flame/fire retardants, salts, cellulose fibres, hemp fibres, cotton fibres, coconut fibres, polyethylene glycol, poloxamers, or a mixture thereof.

Furthermore, the circular foam may further comprise grease, for example stearic acid and/or palmitic acid.

It will be understood that the additive or additives may be added to the circular foam and/or incorporated in the circular foam.

Experiments showed that said additives may provide effective and efficient flexibility, comfortability, stability, and toughness to the circular foam. As a result, the circular foam according to the invention may be tailored to the needs of the end user of the cushion or matrass.

In one of the presently preferred embodiments, the circular foam may comprise a density of 20 kg m⁻³ to 100 kg m⁻³, preferably may comprise a density of 35 kg m⁻³ to 100 kg m⁻³, more preferably may comprise a density of 50 kg m 3 to 100 kg m⁻³.

It was found that a circular foam comprising a density of 20 kg m 3 to 100 kg m⁻³, preferably may comprise a density of 35 kg m 3 to 100 kg m⁻³, more preferably may comprise a density of 50 kg m 3 to 100 kg m⁻³, efficient and effective comfortability, stability, toughness, and flexibility was achieved.

In one of the presently preferred embodiments, the circular foam may comprise a hysteresis loss rate of 10% to 75%, preferably may comprise a hysteresis loss rate of 30% to 75%, more preferably may comprise a hysteresis loss rate of 40% to 60%, as determined according to NEN-EN-ISO 2439:2009 Method E.

An advantage of the above mentioned hysteresis loss rate is that the circular foam according to the invention is returning back to substantially its initial shape after the transients have died out. As a result, the circular foam may be used multiple times.

In one of the presently preferred embodiments, the circular foam may comprise an indentation load deflection of 80 N to 220 N at 40% compression, preferably may comprise an indentation load deflection of 90 N to 210 N at 40% compression, more preferably may comprise an indentation load deflection of 100 N to 200 N at 40% compression, as determined according to NEN EN 2439 B. NEN EN 2439 B is also referred to as NEN-EN-ISO 2439:2009 Method B.

An advantage of the above mentioned indentation load deflection, wherein the indentation load deflection is determined in Newton (N), is that the indentation load deflection enables an efficient and effective circular foam for cushions and matrasses.

In one of the presently preferred embodiments, the open cell structure comprises an open cell content of at least 30% measured according to mercury porosimetry or gas physisorption, preferably the open cell content comprises at least 40% measured according to mercury porosimetry or gas physisorption, more preferably the open cell content comprises at least 50% measured according to mercury porosimetry or gas physisorption, most preferably the open cell content comprises at least 60% measured according to mercury porosimetry or gas physisorption. This means that at least 30% of the circular foam is provided as an opening, pore, void and their connections in the form of channels. This open cell content can be measured in accordance with mercury porosimetry or gas physisorption. This measurement is used to measure specific surface areas and pore sizes with a pore size distribution. It will be understood that other suitable measurements can also be performed.

Preferably the open cell structure comprises an open cell content of the circular foam of at least 40% measured according to mercury porosimetry or gas physisorption, preferably the open cell content of the circular foam is at least 50% measured according to mercury porosimetry or gas physisorption, more preferably the open cell content of the circular foam is at least 60% measured according to mercury porosimetry or gas physisorption.

It is noted that the open cell content relates to the total content of the circular foam.

By providing the circular foam with a relatively small open cell content comfort and stability is increased, and an effective and efficient circular foam is achieved. In addition, the cushions and matrass have a prolonged lifetime. This reduces the environmental footprint and replacement frequency. The open cell content may for example be determined using a Keyence microscope VXH-7000 with a Z20 lens and using the integrated software.

In one of the presently preferred embodiments, the circular foam may comprise an average cell size in the range of 0.001 to 3.0 millimetres, preferably in the range of 0.01 to 2.0 millimetres, more preferably in the range of 0.01 to 1.5 millimetres, wherein the cells may be interconnected voids.

A circular foam having an average cell size in the range or one of the ranges as mentioned enables a dense foam which provides effective and efficient stability and comfortability. Preferably, 75% of the voids have a cell size within the range or ranges as mentioned, more preferably 95% of the voids have a cell size within the range or ranges as mentioned. It will be understood that this percentage refers to the amounts of voids by number. This relates to the actual distribution of the cell sizes. The cell size is defined by the characteristic length or diameter of the void. The cell size is determined by counting the number of cell walls over a predefined length in two directions, in accordance to ASTM 3576-15. Preferably method B of ASTM 3576-15 is applied. Alternatively, the cell size is determined using imaging software. For example, the open source software ImageJ with Fiji plugin.

In one of the presently preferred embodiments, the circular polymer may be selected from the group of polybutylene sebacate terephthalate and/or polybutylene adipate terephthalate.

It was shown that the use of polybutylene sebacate terephthalate and/or polybutylene adipate terephthalate provides an effective circular foam that is circular and may be biodegradable and compostable. In addition, it was shown that it also provides the improved possibility to provide stability and comfort to users, while enabling the circular foam to return to substantially its desired shape. These circular polymers especially contribute to the flexibility and toughness of the resulting circular foam for cushions and matrasses.

In addition to, or as an alternative for, the aforementioned circular polymers, the circular polymer may also be one or more circular polymer selected from the group of polyhydroxyalkanoate, poly(lactic acid), polybutylene succinate. These circular polymers can be applied as an alternative to the aforementioned polymers or can be used in a mixture therewith. Such mixture provides a circular foam that is flexible and tough, properties relating to a relatively high elastic modulus and strength. Especially the use of the combination of polybutylene adipate terephthalate and one or more of polyhydroxyalkanoate, poly(lactic acid), polybutylene succinate results in a mixture wherein the polybutylene adipate terephthalate substantially contributes to the flexibility and toughness of the circular foam, and the other circular polymers contribute to the strength and rigidness of the circular foam.

In a preferred embodiment according to the invention, the circular polymer may also be one or more circular polymer selected from the group of polyhydroxyalkanoate, poly(lactic acid), polybutylene succinate, polybutylene sebacate terephthalate, polybutylene adipate terephthalate.

It was found that a mixture of one or more of said circular polymers enables an efficient and effective circular foam for cushions and matrasses.

In a preferred embodiment, the amount of circular polymer selected from the group of polyhydroxyalkanoate, polylactic acid), polybutylene succinate in a mixture with polybutylene sebacate terephthalate and/or polybutylene adipate terephthalate may be in the range of 10 to 90 wt %, preferably in the range of 10 to 60 wt %, and most preferably in the range of 10 to 30 wt %. It was shown that such mixture provides a circular foam with an open cell structure having good properties for cushions and matrasses.

In one of the presently preferred embodiments, the polyester and/or aromatic polymer may be branched. Preferably, the nucleating agent is selected from the group of talc, cellulose, hydrotalcite, calcium hydroxide, sodium carbonate, sodium bicarbonate, potassium carbonate, potassium bicarbonate, aluminium carbonate, aluminium bicarbonate, calcium carbonate, calcium bicarbonate, calcium stearate, or a mixture thereof.

In an alternative embodiment according to the invention, the additive selected from the group of (natural) antimicrobials, bacteria retardants, such as silver compounds, chitin, chitosan, flame/fire retardants, salts, cellulose fibres, hemp fibres, cotton fibres, coconut fibres, polyethylene glycol, poloxamers, may act as a nucleating agent. Preferably, one or more of said additives is mixed with one or more of the nucleating agents selected from the group of talc, cellulose, hydrotalcite, calcium hydroxide, sodium carbonate, sodium bicarbonate, potassium carbonate, potassium bicarbonate, aluminium carbonate, aluminium bicarbonate, calcium carbonate, calcium bicarbonate, calcium stearate, and used as nucleating agent.

The branching contributes to providing a compact/dense, open cell structure. It was shown that the use of a nucleating agent as one or more components from the aforementioned group provides an efficient circular foam according to the invention.

In one of the presently preferred embodiments, the circular foam may be an integrally extruded circular foam.

Extruding the circular foam integrally involves the extrusion of the circular foam within the extruder. Therefore, the extruder is provided with multiple zones, such zones are for example an intake zone, injection zone, and mixing zone. Expansion of the circular foam is achieved within and/or after a mould or die.

A further advantage of such integrally extruded circular foam is that the foam is dry and free of solvents when it is expanded. This reduces the costs of drying and/or removing any solvent.

Furthermore, the (development of) pores of such integrally extruded circular foam are controlled in an efficient manner. To provide a circular foam for a cushion or a matrass it is preferred to have equal pore sizes to obtain uniform comfortability, stability, and flexibility. This enables efficient and effective cushions and matrasses.

An even further advantage is that the integrally extruded foam is sterile, thus free of bacteria, fungi and insects. Therefore, allergic reactions are reduced. For example, allergic reactions to dust mites.

Therefore, an integrally extruded foam is more efficient and effective. Furthermore, an integrally extruded foam may be achieved in a single step process. This reduces the number of handlings of an operator.

In addition, the integrally extruded foam enables to perform a continuous process. Therefore, the production of the circular foam may be endless, and the material lost during start-up and finishing is reduced.

Thus, overall, a more efficient, such as energy efficient, process is achieved.

In one of the preferred embodiments, the circular foam may have pores with a total volume in the range of 0.5 to 100 cm³ g⁻¹, preferably in the range of 0.5 to 50 cm³ g⁻¹, more preferably in the range of 1.0 to 25 cm³ g⁻¹. The circular foam according to the invention is capable of containing and/or absorbing heat, such as body heat, with its relevant components in its cells, to which is also referred to as openings, voids, pores, wherein the cells are preferably interconnected with each other. Therefore, the circular foam is enabled to isolate and retain (body) heat.

Preferably, the pores have a total volume with at least 75% of the total pore volume being within this range, more preferably the pores have a total volume with at least 95% of the total pore volume being within this range.

In one of the preferred embodiments, the cells and the total volume of the pores of the circular foam may, substantially, be the same. The circular foam according to the invention is capable of containing and/or absorbing heat in its cells, to which is also referred to as openings, voids, pores, wherein the cells are preferably interconnected with each other. The isolating properties of the circular foam according to the invention is even further improved when the cells are substantially the same. It will be understood these cells of such sponge-like structure may expand or compress equally and provide efficient and effective distribution of the heat and provide efficient and effective stability.

A further advantage is that ventilation and/or air transport is enabled. As a result, moisture may be removed from the circular foam according to the invention in an efficient and effective manner.

In one of the preferred embodiments, the circular foam preferably has a glass-transition temperature of at most 60° C. or less, preferably a glass-transition temperature of at most 30° C. or less, more preferably a glass-transition temperature of at most 0° C. or less, most preferably a glass-transition temperature of at most −20° C. or less. The circular foam density is preferably in the range of 20 kg m⁻³ to 100 kg m⁻³, more preferably the circular foam density is in the range of 35 kg m⁻³ to 100 kg m⁻³, even more preferably the circular foam density is in the range of 50 kg m⁻³ to 100 kg m⁻³. The weight average molecular weight of the circular and/or virgin polymer is preferably in the range of 10.000 g mol⁻¹ to 1.000.000 g mol⁻¹, preferably the weight average molecular weight of the circular and/or virgin polymer is in the range of 10.000 g mol⁻¹ to 500.000 g mol⁻¹, more preferably the weight average molecular weight of the circular and/or virgin polymer is in the range of 20.000 g mol⁻¹ to 250.000 g mol⁻¹, most preferably the weight average molecular weight of the circular and/or virgin polymer is in the range of 30.000 g mol⁻¹ to 150.000 g mol⁻¹. The weight average molecular weight was determined by gel permeation chromatography (GPC) according to ISO 13885-1. It is noted that ISO 13885-1 refers to ISO 13885-1:2018.

Experiments showed that providing the circular foam with the aforementioned properties provides an effective and efficient circular foam for cushions and matrasses. Preferably, the circular foam fulfils all of the aforementioned properties to have the most optimum conditions for cushions and matrasses.

It was shown that a circular foam comprising a total pore volume in the range of 0.5 to 100 cm³ g⁻¹, preferably 0.5 to 50 cm³ g⁻¹, more preferably in the range of 1.0 to 25 cm³ g⁻¹, a glass-transition temperature of at most 0° C. or less, preferably −20° C. or less, a circular foam density in the range of 20 kg m 3 to 100 kg m⁻³, preferably in the range of 35 kg m 3 to 100 kg m⁻³, a weight average molecular weight in the range of 20.000 g mol⁻¹ to 250.000 g mol⁻¹, preferably in the range of 30.000 g mol⁻¹ to 150.000 g mol⁻¹, wherein at least 75%, preferably at least 95% of the voids have a cell size within the average cell size range of 0.01 to 2.0 millimetres, preferably in the range of 0.01 to 1.5 millimetres provided an efficient and effective circular foam for cushions and matrasses. Such circular foam provided efficient and effective stability, toughness, comfortability, and flexibility due to the combination of pore volume and circular foam density. Furthermore, the circular foam provided efficient and effective support for the flexibility.

A further advantage of the circular foam for cushions and matrasses is that the circular foam according to the invention is the circularity of the material and/or easily compostable, if desired, due to the combination of pore volume and circular foam density.

The invention also relates to a cushion comprising a cover and circular foam for cushions and matrasses according to an embodiment of the present invention.

Such cushion provides similar effects and advantages as described for the circular foam.

A further advantage of the cushion according to the invention is that the waste stream is reduced, and that the cushion may be used to make fresh circular foam. Furthermore, in a possible embodiment according to the invention, the cushion may be biodegradable. This reduces the impact on the environment even further, as (additional) landfill is prevented.

The invention also relates to a matrass comprising a cover and circular foam for cushions and matrasses according to an embodiment of the present invention, wherein the circular foam is configured as a single layer. Preferably, the matrass further comprises pocket springs and at least one additional layer.

Such matrass provides similar effects and advantages as described for the circular foam and cushion.

In a preferred embodiment of the invention, the additional layer is made of natural materials such as hemp fibres, coconut fibres, feathers, hair, bamboo, cotton, and the like.

A further advantage of the matrass according to the invention is that the waste stream is reduced, and that the matrass may be used to make fresh circular foam. Furthermore, in a possible embodiment according to the invention, the matrass may be biodegradable. This reduces the impact on the environment even further, as (additional) landfill is prevented.

The invention also relates to a method for producing circular foam, comprising the steps of:
providing circular foam and/or circular polymer to an extruder;
heating the circular foam and/or circular polymer forming a mixture;
providing a physical blowing agent to the mixture; and
substantially completely extruding of the mixture to form circular foam according to an embodiment of the present invention,
wherein the circular foam of the step of providing circular foam and/or circular polymer to an extruder comprises circular foam according to an embodiment of the present invention.

Such method provides similar effects and advantages as described for the circular foam, cushion, and matrass.

Preferably, the method according to the invention relates to a method for producing circular foam for furniture, matrasses, noise reduction, and/or cushioning.

The method according to the invention comprises the step of providing circular foam and/or circular polymer to an extruder. The circular foam and the circular polymer may be mixed before provided to the extruder. The step of providing circular foam and/or circular polymer to an extruder may be followed by the step of heating the circular foam and/or circular polymer forming a mixture. Heating the circular foam and/or circular polymer enables to form an (integrally) extruded circular foam. In addition to the heating step, the step of providing a physical blowing agent to the mixture may be performed. Providing the physical blowing agent enables to form cells in the mixture, before the step of substantially completely extruding of the mixture to form circular foam according to the invention is performed.

It is noted that the circular foam and/or circular polymer may form a mixture before being provided to the extruder.

To provide a circular foam according to the invention, a circular foam according to the invention may be used to manufacture said circular foam. This enables to provide an efficient and effective circular method and circular foam.

An advantage of the method according to the invention is that degradation of the circular polymer chains is reduced. As a result, the circular polymer may comprise substantially the same properties compared to virgin polymer. Therefore, the circular polymer may be used in high end applications such as cushions and matrasses.

In a presently preferred embodiment, the method may comprise the step of cutting the circular foam prior to the step of providing circular foam and/or circular polymer to an extruder. Preferably, the method may further comprise the step of forming circular particles from the circular foam by heating the circular foam, wherein the circular particles are provided to the extruder.

Cutting the circular foam into pieces enables an efficient and effective mixing with the circular polymer and/or heating of the mixture. It was found that cutting the circular foam provides an efficient and effective extrusion of the mixture.

It is noted that in this application cutting may refer to carving, slicing, grinding, milling, crunching, and the like.

The step of forming circular particles from the circular foam by heating the circular foam includes melting the circular foam and/or shaping the melted foam into circular particles. Thus, the circular particles are made of the circular foam, wherein the pores and the cells are removed from the circular foam. Said circular particles are easier to dose to an extruder, easier to handle, and more efficient to transport compared to a foam.

In a preferred embodiment, a virgin polymer is provided to the extruder together with the circular foam and/or circular polymer.

The invention also relates to a circular foam for cushions and matrasses according to an embodiment of the present invention obtainable by the method according to an embodiment of the present invention.

Such circular foam provides similar effects and advantages as described for the circular foam, the cushion, the matrass, and the method.

The invention also relates to use of the circular foam according to an embodiment of the invention in a matrass according to an embodiment of the invention. In an alternative embodiment, the invention relates to use of the circular foam according to an embodiment of the invention in a cushion according to an embodiment of the invention.

Such use of the circular foam provides similar effects and advantages as described for the circular foam, the cushion, the matrass, and the method.

Further advantages, features and details of the invention are elucidated on the basis of preferred embodiments thereof, wherein reference is made to the accompanying drawings, in which:

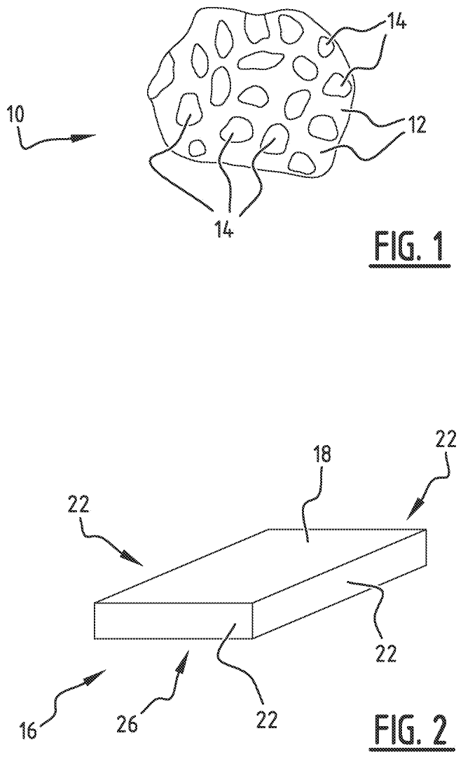

FIG. 1 shows a schematic overview of part of the circular foam according to the invention;

FIG. 2 shows a schematic overview of a sample of the circular foam according to the invention;

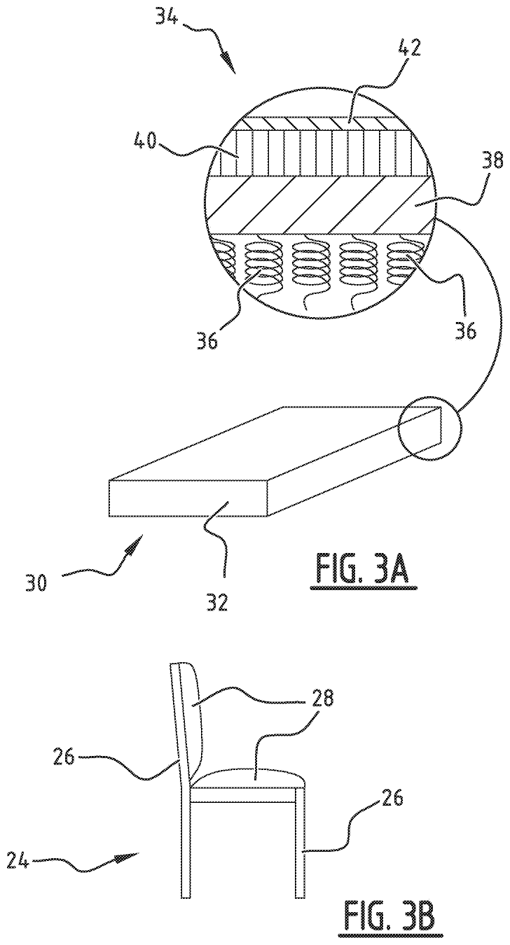

FIG. 3A shows a schematic overview of a matrass comprising the circular foam according to the invention;

FIG. 3B shows a schematic overview of a chair comprising cushions according to the invention; and

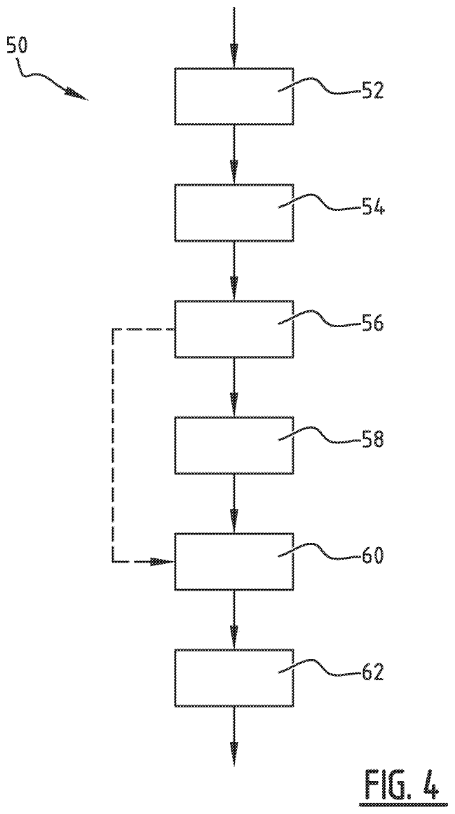

FIG. 4 shows a schematic overview of the method according to the invention.

Part of circular foam 10 (FIG. 1) comprises cells 14, which may be open cells and form interconnected voids, and circular foam 12. Circular foam 12 forms cells 14.

Sample of circular foam 16 (FIG. 2) is made of circular foam according to the invention and comprises top 18, sides 22, and bottom 20. It is noted that sample of circular foam 16 is by no means limited to the shape of FIG. 2. For example, the shape of circular foam 16 may be round, oval, squared, and the like, or any other desirable shape.

Chair 24 (FIG. 3B) comprises frame 26 and cushions 28. Cushions 28 are made of circular foam according to the invention.

Matrass 30 (FIG. 3A) comprises cover 32, optionally cover 32 may comprise closing means such as a zipper or Velcro.

FIG. 3A shows also schematic overview 34 of an embodiment of the inside of matrass Overview 34 comprises pocket springs 36, additional layer 38, circular foam 40, and side view 42 of cover 32.

Method for producing circular foam for furniture 50 (FIG. 4) starts with step 52 of cutting the circular foam, to form small particles of the (old) circular foam, may be followed by step 54 of adding virgin polymer to the cut circular foam. Step 52 or step 54 is followed by step 56 of heating the circular foam and/or circular polymer forming a mixture. Step 56 may be followed by step 58 of forming circular particles from the circular foam by heating the circular foam, wherein the circular particles are provided to the extruder. Step 56 or step 58 is followed by step 60 of providing a physical blowing agent to the mixture and step 62 of substantially completely extruding of the mixture to form circular foam according to the invention.

Experiments showed that the desired indentation load deflection was achieved, wherein in the experiment a circular foam of 1 m×2 m×30 cm was used.

Further experiments showed that the volatile organic compounds (VOC) could be determined by DIN EN 16516. It was found the circular foam according to the invention provides volatile organic compounds values which are suitable for use by consumers. Results of the tests are shown in Tables 1 to 6.

TABLE 1
Carcinogenic, mutagenic, and reproductive toxic components

| | Concen- | |
|---|---|---|
| | tration | |
| | after 3 days | SERa |
| Carcinogenic, mutagenic and reproductive | [μg/ | [μg/ |
| toxic components* | (m² h)] | (m² h)] |
| CMR 1: VOC (incl. very VOC and semi VOC) | <1 | <0.77 |
| with the following categorisations: | | |
| Regulation (EC) No. 1272/2008: Category Carc. | | |
| 1A and 1B, Muta. 1A and 1B, Repr. 1A and 1B; | | |
| TRGS 905: K1A, K1B, M1A, M1B, R1A, R1B; | | |
| IARC: Group 1 and 2A; | | |
| DFG (MAK list): Categories III1, III2 | | |
| C 1: VOC (incl. VVOC and SVOC) with the | <1 | <0.77 |
| following categorisations: | | |
| Regulation (EG) Nr. 1272/2008: Category Carc. | | |
| 1A u. 1B | | |

*Excluding formaldehyde (Carc. 1B) due to an assumed “practical threshold” under which a significant carcinogenic risk is no longer to be expected (see German Federal Institute for Risk Assessment (2006): Toxicological evaluation of formaldehyde and German Federal Environment Agency (2016): Reference value for formaldehyde in indoor air). In the case of a toxicological emission assessment, a single-substance analysis of the formaldehyde concentration is necessary. In the opinion of the committee for Indoor Air guide Values (Ausschuss für Innenraumrichtwerte) of the German Federal Environment Agency, the concentration of 0.1 mg formaldehyde/m³ indoor air, based on a measurement period of half an hour, should not be exceeded, also for a short time (Bundesgesundheitsblatt 2016, 59, 1040-1044, DOI 10.1007/s00103-016-23895).

TABLE 2
Total volatile organic compounds

| | Concen- | |
|---|---|---|
| | tration | |
| | after 3 days | SERa |
| | [μg/ | [μg/ |
| Total volatile organic compounds | (m² h)] | (m² h)] |
| Sum of VOC according to DIN EN 16516 | 16 | 12 |
| Sum of VOC according to AgBB 2018/DIBt | 21 | 16 |
| Sum of VOC according to eco-INSTITUT-Label | 27 | 21 |
| Sum of VOC according to ISO 16000-6 | 37 | 28 |

TABLE 3
Total semi volatile organic compounds

| | Concen- | |
|---|---|---|
| | tration | |
| | after 3 days | SERa |
| | [μg/ | [μg/ |
| Total semi volatile organic compounds | (m² h)] | (m² h)] |
| Sum of semi VOC according to DIN EN 16516 | <5 | <3.85 |
| Sum of semi VOC without LCI according to | <5 | <3.85 |
| AgBB 2018/DIBt | | |
| Sum of semi VOC without LCI according to | <1 | <0.77 |
| eco-INSTITUT-Label | | |
| Sum of semi VOC with LCI according to AgBB | <5 | <3.85 |
| 2018/DIBt | | |

TABLE 4
Total very volatile organic compounds

| | Concentration | |
|---|---|---|
| | after 3 days | SERa |
| Total very volatile organic compounds | [μg/(m² h)] | [μg/(m² h)] |
| Sum of very VOC according to AgBB | 6 | 4.6 |
| 2018/DIBt and Belgian regulation | | |
| Sum of very VOC according to | 8 | 6.2 |
| eco-INSTITUT-Label | | |

TABLE 5
Other sums of volatile organic compounds

| | Concen- | |
|---|---|---|
| | tration | |
| | after 3 days | SERa |
| | [μg/ | [μg/ |
| Other sums of VOC | (m² h)] | (m² h)] |
| VOC without LCI according to AgBB/DIBt and | 16 | 12 |
| Belgian regulation | | |
| VOC without LCI according to eco-INSTITUT- | 21 | 16 |
| Label | | |
| CMR 2: VOC (incl. very VOC and semi VOC) | 8 | 6.2 |
| with the following categorisations: | | |
| Regulation (EC) No. 1272/2008: Category | | |
| Carc. 2, Muta. 2, Repr. 2; | | |
| TRGS 905: K3; | | |
| IARC: Group 2B; | | |
| DFG (MAK list): Category III3 | | |
| Sensitising compounds with the following | | |
| categorisations: DFG (MAK list): Category IV, | | |
| German Federal Institute for Risk Assessment | | |
| lists: Cat A, TRGS 907 | | |
| Bicyclic Terpenes | <1 | <0.77 |
| C₉-C₁₄: Alkanes/Isoalkanes as dekane-equivalent | <1 | <0.77 |
| C₄-C₁₁ Aldehydes, acyclic, aliphatic | <2 | <1.54 |

TABLE 6
Risk value for assessment of LCI

| Risk value for assessment of LCI | R-Value |
|---|---|
| R-value according to eco-INSTITUT-Label | 0.03 |
| R-value according to AgBB 2018/DIBt | 0.01 |
| R-value according to Belgian regulation | 0.01 |
| R-value according to AFSSET | 0.05 |

It is noted that due to different requirements in the respective guidelines, the calculation of total VOC, total very VOC, total semi VOC and R-value may result in different values. Short-chain carbonyl compounds (C₁-C₅) are quantified via HPLC according to DIN ISO 1600-3:2013-01. Therefore, no toluene equivalents are given for very VOC. These substances are taken into concern by means of their substance specific calibration via the sum of very VOC according to DIN EN 16516:2018-01. For VOC however, the substance specific calibration takes place via HPLC (whereas the total VOC is calculated using the toluene equivalent determined via Tenax according to DIN EN 16516:2018-01).

The present invention is by no means limited to the above described preferred embodiments and/or experiments thereof. The rights sought are defined by the following claims within the scope of which many modifications can be envisaged.

1. A circular foam for cushions and mattresses, comprising a circular polymer and a nucleating agent, wherein the circular polymer is a polyester and/or an aromatic polymer, wherein the circular foam comprise an open cell structure and a fatigue of at most 15% as determined according to ISO 1856:2018.

2. The circular foam for cushions and mattresses according to claim 1, further comprising reclaimed foam, wherein the reclaimed foam comprises the circular polymer and a nucleating agent.

3. The circular foam for cushions and mattresses according to claim 1, wherein the fatigue of the circular foam is at most 10%.

4. The circular foam for cushions and mattresses according to claim 1, wherein the circular foam comprises at least 70 wt. % circular polymer.

5. The circular foam for cushions and mattresses according to claim 1, further comprising at most 30 wt. % virgin polymer, and wherein the virgin polymer is a biodegradable polymer.

6. The circular foam for cushions and mattresses according to claim 1, wherein the circular polymer is a biodegradable polymer.

7. The circular foam for cushions and mattresses according to claim 1, wherein the circular foam comprises a density of 20 kg m−3 to 100 kg m−3, and/or wherein the circular foam comprises a hysteresis loss rate of 10% to 75 determined according to NEN-EN-ISO 2439:2009 Method E, and/or wherein the circular foam comprises an indentation load deflection of 80 N to 220 N at 40% compression as determined according to NEN-EN-ISO2439:2009 Method B.

8-9. (canceled)

10. The circular foam for cushions and mattresses according to claim 1, wherein the open cell structure comprises an open cell content of at least 30% measured according to mercury porosimetry or gas physisorption, and/or wherein the circular foam further comprising an average cell size in the range of 0.001 to 3.0 millimetres, wherein the cells are interconnected voids.

11. (canceled)

12. The circular foam for cushions and mattresses according to claim 1, wherein the circular polymer is selected from the group of polybutylene sebacate terephthalate and/or polybutylene adipate terephthalate.

13. The circular foam for cushions and mattresses according to claim 1, wherein the circular polymer is one or more of the group polyhydroxyalkanoate, poly(lactic acid), polybutylene succinate.

14. The circular foam for cushions and mattresses according to claim 1, wherein the polyester and/or aromatic polymer is branched.

15. The circular foam for cushions and mattresses according to claim 1, wherein the nucleating agent is selected from the group of talc, cellulose, hydrotalcite, calcium hydroxide, sodium carbonate, sodium bicarbonate, potassium carbonate, potassium bicarbonate, aluminium carbonate, aluminium bicarbonate, calcium carbonate, calcium bicarbonate, calcium stearate, or a mixture thereof, and/or wherein the circular foam is an integrally extruded circular foam.

16. (canceled)

17. A cushion comprising a cover and circular foam for cushions and mattresses according to claim 1.

18. A mattress comprising a cover and circular foam for cushions and mattresses according to claim 1, wherein the circular foam is configured as a single layer.

19. The matrass according to claim 18, wherein the mattress further comprises pocket springs and at least one additional layer.

20. Method for producing circular foam, comprising the steps of:
providing circular foam and/or circular polymer to an extruder;
heating the circular foam and/or circular polymer forming a mixture;
providing a physical blowing agent to the mixture; and
substantially completely extruding of the mixture to form a circular foam substrate, comprising a circular polymer and a nucleating agent, wherein the circular polymer is a polyester and/or an aromatic polymer, and wherein the circular foam comprises an open cell structure and a fatigue of at most 15% as determined according to ISO 1856:2018;
wherein the circular foam of the step of providing circular foam and/or circular polymer to an extruder comprises said circular foam.

21. A method for producing circular foam according to claim 20, further comprising the step of cutting the circular foam prior to the step of providing circular foam and/or circular polymer to an extruder, and/or further comprising the step of forming circular particles from the circular foam by heating the circular foam, wherein the circular particles are provided to the extruder.

22. (canceled)

23. Circular foam for cushions and mattresses according to claim 1 obtainable by the method according to claim 20.

24. Use of a circular foam according to claim 1 in a mattress comprising a cover and said circular foam, wherein said circular foam is configured as a single layer.

25. Use of a circular foam according to claim 1 in a cushion comprising a cover and said circular foam for cushions and mattresses.
